(19) United States
(12) Patent Application Publication
(10) Pub. No.: US 2017/0173933 A1
(43) Pub. Date: Jun. 22, 2017

(54) METHOD FOR ADHERING METAL LAYER AND POLYMER LAYER AND METHOD FOR MANUFACTURING METAL ELECTRODE

(71) Applicant: ELECTRONICS AND TELECOMMUNICATIONS RESEARCH INSTITUTE, Daejeon (KR)

(72) Inventors: Yong Hee KIM, Daejeon (KR); Sang-Don JUNG, Daejeon (KR)

(21) Appl. No.: 15/223,505

(22) Filed: Jul. 29, 2016

(30) Foreign Application Priority Data
Dec. 17, 2015 (KR) 10-2015-0181042

(51) Int. Cl. B32B 37/12; B32B 38/10; C25D 3/56; B32B 37/26; C23F 1/02; B32B 37/14

(52) U.S. Cl. CPC B32B 37/12; C23F 1/02; B32B 37/144; C25D 3/56; B32B 37/26; B32B 38/10; B32B 2310/021

(57) ABSTRACT

A method for adhering a metal layer and a polymer layer includes forming a metal layer, forming a nanoporous metal structure on the metal layer, and compressing a polymer layer on the nanoporous metal structure such that a polymer is infiltrated into the nanoporous metal structure.

### CROSS-REFERENCE TO RELATED APPLICATION

The present application claims priority to Korean patent application number 10-2015-0181042 filed on Dec. 17, 2015, the entire disclosure of which is incorporated herein in its entirety by reference.

### BACKGROUND

1. Field

An aspect of the present disclosure relates to a method for adhering a metal layer and a polymer layer, and more particularly, to a method for increasing an adhesion between a metal layer and a polymer layer using a nanoporous metal structure and a method for manufacturing a metal electrode using the same.

2. Description of the Related Art

An assembly of a polymer film and a metal has both the flexibility of the polymer film and the conductivity of the metal. Thus, the assembly is used in various fields including devices and systems for body implantation or body attachment, flexible touch screens, metal corrosion prevention, and the like.

However, if a stable metal such as gold (Au) or platinum (Pt) is adhered to a polymer, the adhesion between the metal and the polymer is weak, and hence the metal is easily separated from the polymer. Accordingly, in order to increase the adhesion between the polymer and the metal such as Au or Pt, an adhesive layer made of chromium (Cr), titanium (Ti), etc., which has a relatively higher adhesion than the polymer, is typically interposed between the metal and the polymer.

However, in the case of an assembly to which an adhesive layer made of Cr, Ti, etc. is applied, if the assembly is used for a long period of time, the assembly is corroded, or the adhesion of the assembly becomes weak, due to body fluid, sweat, repeated mechanical stimuli, etc. In addition, a metal such as Au or Pt is eventually separated from a polymer film.

### SUMMARY

Embodiments provide an adhesion method for increasing an adhesion between a metal layer and a polymer layer without any adhesive layer and a method for manufacturing a metal electrode using the same.

According to an aspect of the present disclosure, there is provided a method for adhering a metal layer and a polymer layer, the method including: forming a metal layer; forming a nanoporous metal structure on the metal layer; and compressing a polymer layer on the nanoporous metal structure such that a polymer is infiltrated into the nanoporous metal structure.

According to an aspect of the present disclosure, there is provided a method for manufacturing a metal electrode, the method including: forming, on a sacrificial substrate, a first mold including a first opening having an undercut structure; forming a metal electrode in the first opening; forming a second mold including a second opening exposing the metal electrode therethrough; forming a first nanoporous metal structure on a first surface of the metal electrode exposed through the second opening; compressing a first polymer layer on the first nanoporous metal structure such that a polymer is infiltrated into the first nanoporous metal structure; removing the sacrificial substrate such that a second surface of the metal electrode is exposed; forming a third mold including a third opening exposing the second surface of the metal electrode therethrough; and forming a second nanoporous metal structure on the second surface of the metal electrode exposed through the third opening.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a sectional view illustrating a configuration of an adhesive structure according to an embodiment of the present disclosure.

FIGS. 2A to 2G are sectional views illustrating a method for adhering a polymer layer and a metal layer according to an embodiment of the present disclosure.

FIG. 3 is a transmission electron microscope (TEM) photograph of a nanoporous gold structure according to an embodiment of the present disclosure.

FIGS. 4A to 4N are sectional views illustrating a method for manufacturing an electrode and an electrode array according to an embodiment of the present disclosure.

### DETAILED DESCRIPTION

Hereinafter, exemplary embodiments of the present disclosure will be described. In the drawings, the thicknesses and the intervals of elements are exaggerated for convenience of illustration, and may be exaggerated compared to an actual physical thickness. Variations from the shapes of the illustrations as a result, for example, of manufacturing techniques and/or tolerances, are to be expected. Thus, exemplary embodiments should not be construed as limited to the particular shapes of regions illustrated herein but may be to include deviations in shapes that result, for example, from manufacturing. Singular forms in the present disclosure are intended to include the plural forms as well, unless the context clearly indicates otherwise. In describing the present disclosure, a publicly known configuration irrelevant to the principal point of the present disclosure may be omitted.

FIG. 1 is a sectional view illustrating a configuration of an adhesive structure according to an embodiment of the present disclosure.

Referring to FIG. 1, the adhesive structure according to the embodiment of the present disclosure includes a polymer layer 10, a nanoporous metal structure 11 in which a polymer is infiltrated into pores having a nano-size, and a metal layer 12. Here, the nanoporous metal structure 11 is interposed between the polymer layer 10 and the metal layer 12, and increases an adhesion between the polymer layer 10 and the metal layer 12. The polymer layer 10 is formed of a material having a glass transition temperature and a melting point, and includes, for example, a fluorine-based resin polymer including fluorinated ethylene propylene (FEP).

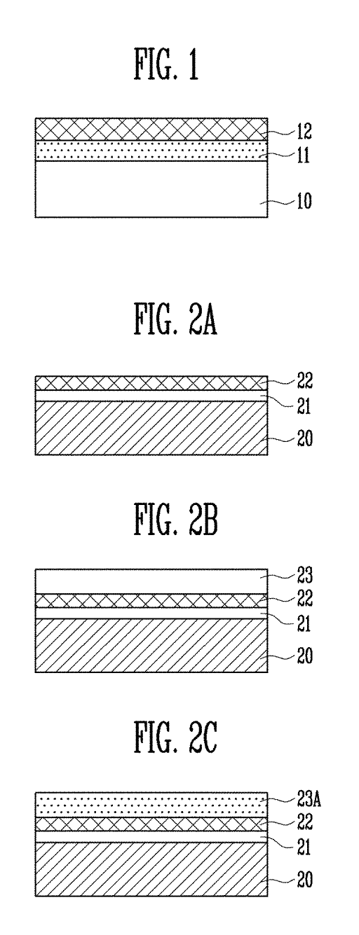

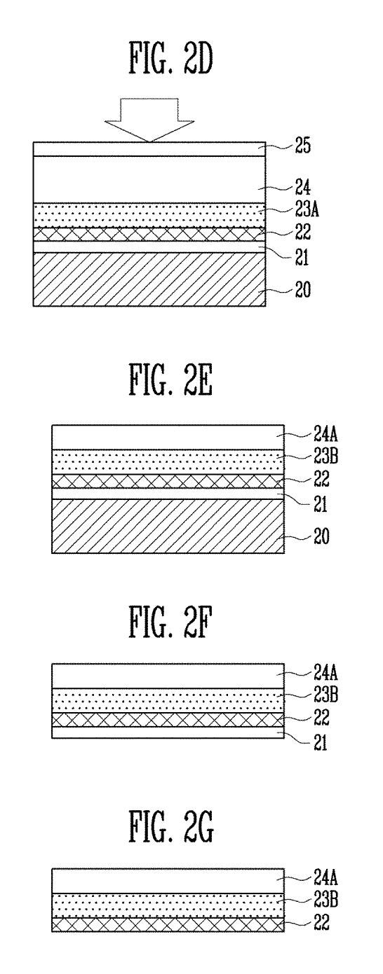

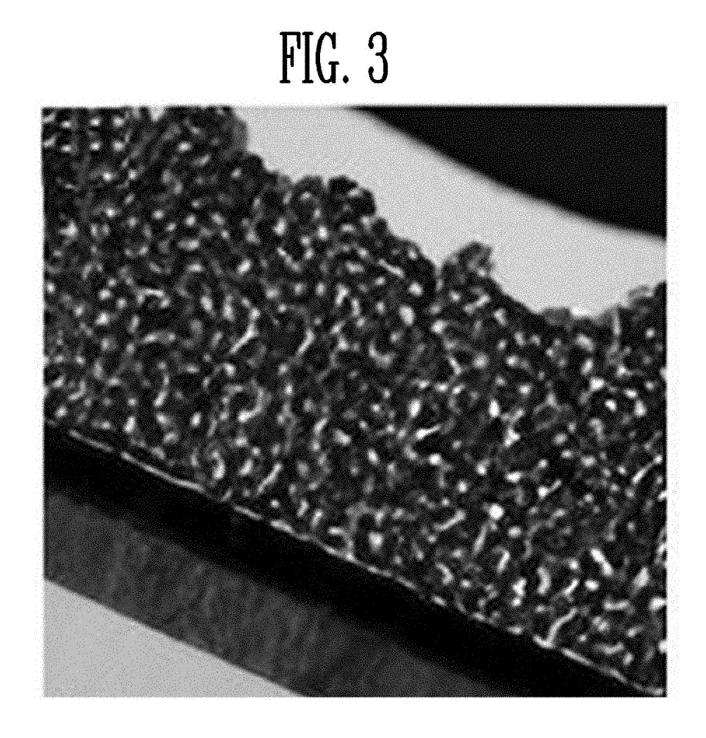

FIGS. 2A to 2G are sectional views illustrating a method for adhering a polymer layer and a metal layer according to an embodiment of the present disclosure.

Referring to FIG. 2A, an adhesive layer 21 is formed on a sacrificial substrate 20, and a metal layer 22 is then formed on the adhesive layer 21. A substrate on which wet etching is easily performed may be used as the sacrificial substrate 20. For example, the sacrificial substrate 20 may include a metal substrate made of copper (Cu), aluminum (Al), etc., a silicon substrate, a glass substrate, a glass substrate on which indium tin oxide (ITO) is coated, and the like.

The adhesive layer 21 may be formed using thermal evaporation or electron-beam evaporation, and may include chromium (Cr). The metal layer 22 may include gold (Au).

Referring to FIG. 2B, an alloy layer 23 is formed on the metal layer 22. The alloy layer 23 may be formed using electron-deposition, and includes a first metal and a second metal. The first metal and the second metal may be selected based on whether they are dissolved with respect to a specific etchant. As an example, silver (Ag) dissolved in a nitric acid may be selected as the first metal, and Au not dissolved in the nitric acid may be selected as the second metal, thereby forming an Ag—Au alloy layer. As another example, Au dissolved in potassium iodide (KI) may be selected as the first metal, and platinum (Pt) not dissolved by the KI may be selected as the second metal, thereby forming an Au—Pt alloy layer.

Referring to FIG. 2C, the first metal included in the alloy layer 23 is selectively removed. Accordingly, a nanoporous metal structure 23A including a plurality of pores having a nano-size is formed. In this case, the first metal may be selectively dissolved using a specific etchant. As an example, the silver (Ag) of the Ag—Au alloy layer may be selectively dissolved using the nitric acid as a silver etchant, thereby forming a nanoporous gold structure. As another example, the Au of the Au—Pt alloy layer may be selectively dissolved using the KI as a gold etchant, thereby forming a nanoporous platinum structure. In addition, the first metal may be selectively removed using electrochemical etching through which a specific component can be selectively removed.

Referring to FIG. 2D, a polymer is infiltrated into the nano-size pores included in the nanoporous metal structure 23A. For example, a polymer layer 24 is formed on the nanoporous metal structure 23A, and a polymer included in the polymer layer 24 is then infiltrated into the nanoporous metal structure 23A by applying heat or pressure. At this time, the polymer layer 24 is formed with a sufficient thickness by considering the amount of the polymer infiltrated into the nanoporous metal structure 23A. In addition, the pressure is applied at a constant temperature higher than the glass transition temperature of the polymer. Accordingly, the polymer layer 24 is compressed on the nanoporous metal structure 23A, thereby allowing the polymer to be infiltrated into the nanoporous metal structure 23A. For example, the polymer layer 24 may be compressed on the nanoporous metal structure 23A at a temperature of 50 to 300° C. In this figure, a case where the polymer is infiltrated using a press 25 is illustrated.

Referring to FIG. 2E, the adhesive layer 21, the metal layer 22, the nanoporous metal structure 23B into which the polymer is infiltrated, and the compressed polymer layer 24A are sequentially stacked on the sacrificial substrate 20, and the metal layer 22 and the polymer layer 24A are firmly adhered to each other without any separate adhesive layer.

Referring to FIGS. 2F and 2G, the sacrificial substrate 20 and the adhesive layer 21 are sequentially removed. For example, when a copper substrate is used as the sacrificial substrate 20, the copper substrate may be selectively removed using an etchant in which hydrochloric acid, hydrogen peroxide, and water are mixed in a ratio of 1:1:4. Accordingly, an adhesive structure is formed in which the metal layer 22, the nanoporous metal structure 23B into which the polymer is infiltrated, and the polymer layer 24A are sequentially stacked.

FIG. 3 is a transmission electron microscope (TEM) photograph of a nanoporous gold structure according to an embodiment of the present disclosure. Accordingly, it can be seen that a plurality of pores having a nano-size are included in the nanoporous gold structure.

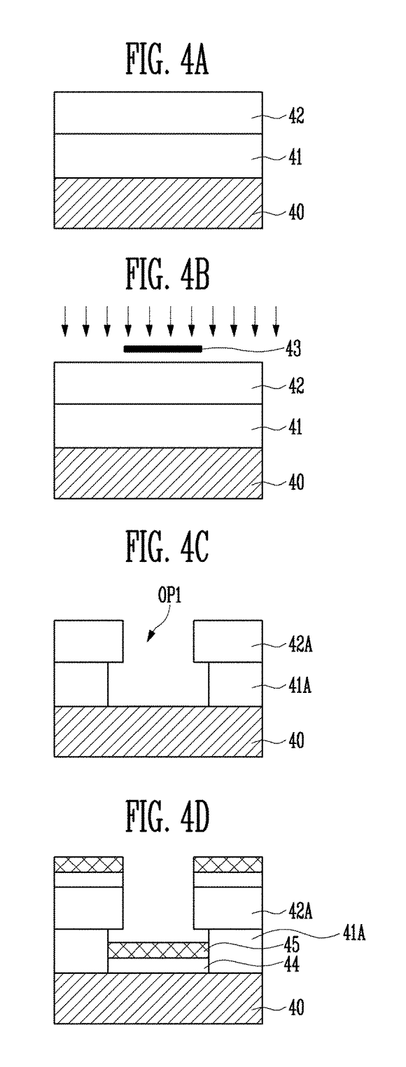

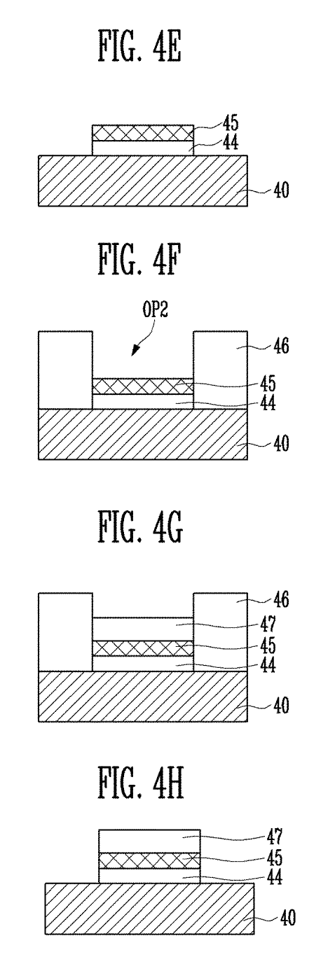

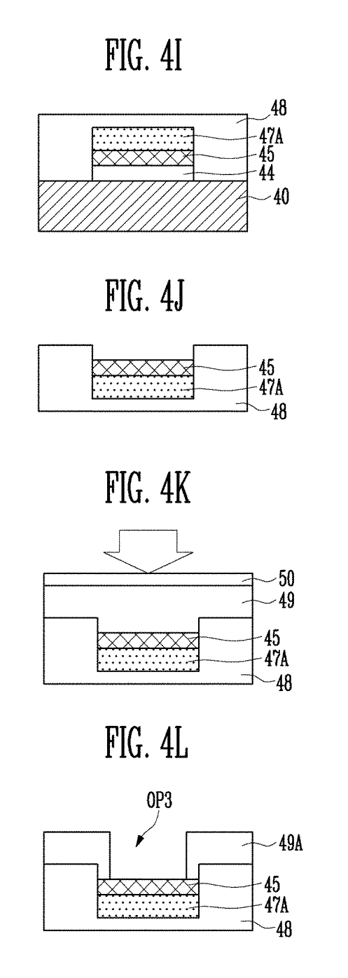

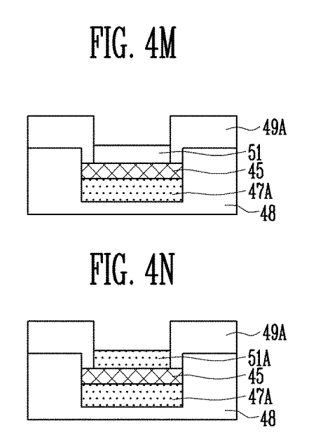

FIGS. 4A to 4N are sectional views illustrating a method for manufacturing an electrode and an electrode array according to an embodiment of the present disclosure.

Referring to FIG. 4A, a lift-off resist layer 41 and a negative photoresist layer 42 are sequentially formed on a sacrificial substrate 40. Here, the sacrificial substrate 40 may be a copper substrate. For example, a spin-coating a lift-off resist (LOR) not sensitive to ultraviolet light may be spin-coated and then heat-treated, thereby forming a lift-off resist thin film. Also, a negative photoresist sensitive to ultraviolet light may be spin-coated and then heat-treated, thereby forming the negative photoresist layer 42 on which an optical pattern can be formed.

Referring to FIGS. 4B and 4C, ultraviolet light is irradiated onto the negative photoresist layer 42 for a certain time, using a photomask 43 in which an electrode pattern having a desired shape is formed and an ultraviolet exposure apparatus. Subsequently, a portion not exposed to the ultraviolet light in the negative photoresist layer 42 is removed, and simultaneously, the lift-off resist layer 41 is restrictively dissolved. Accordingly, the lift-off resist layer 41 and the negative photoresist layer 42 are patterned as a lift-off resist pattern 41A and a negative photoresist pattern 42A, respectively. Thus, a first mold is formed, which includes a first opening OP1 having an undercut structure.

Referring to FIG. 4D, an adhesive layer 44 and a metal layer 45 are formed in the first opening OP1. For example, the adhesive layer 44 and the metal layer 45 may be formed using thermal deposition or electron-beam deposition. The adhesive layer 44 may include Cr and the metal layer 45 may include Au. Also, the metal layer may be a metal electrode. For reference, the adhesive layer 44 and the metal layer 45 may also be formed on the lift-off resist pattern 41A and the negative photoresist pattern 42A.

Referring to FIG. 4E, the lift-off resist pattern 41A and the negative photoresist pattern 42A are removed. At this time, the adhesive layer 44 and the metal layer 45, which are formed on the lift-off resist pattern 41A and the negative photoresist pattern 42A, are removed together.

Referring to FIG. 4F, a positive photoresist pattern 46 is formed on the sacrificial substrate 40 on which the adhesive layer 44 and the metal layer 45 are formed. For example, a positive photoresist thin film is formed with a thick thickness to cover the adhesive layer 44 and the metal layer 45, and then patterned using an additional photomask. Accordingly, the positive photoresist pattern 46, i.e., a second mold is formed, which includes a second opening OP2 exposing the adhesive layer 44 and the metal layer 45 therethrough.

Referring to FIG. 4G a first alloy layer 47 is formed in the second opening OP2 of the positive photoresist pattern 46. For example, the first alloy layer 47 is formed on a first surface of the metal layer 45 using electro-deposition. Here, the first alloy layer 47 may include a first metal and a second metal, and may be made of an Au—Ag alloy.

Referring to FIG. 4H, the positive photoresist pattern 46 is removed. For example, the positive photoresist pattern 46 may be removed using a solvent such as acetone.

Referring to FIG. 4I, the first metal included in the first alloy layer 47 is selectively removed, thereby forming a first nanoporous metal structure 47A, and a polymer substrate 48 is then compressed over the first nanoporous metal structure 47A. At this time, a polymer included in the polymer substrate 48 is infiltrated into the first nanoporous metal structure 47A by applying heat or pressure to the polymer substrate 48. Accordingly, the adhesion between the polymer substrate 48 and the metal layer 45 is increased.

Referring to FIG. 4J, the sacrificial substrate 40 and the adhesive layer 44 are removed. Subsequent processes are performed in a state in which an intermediate resultant structure having the sacrificial substrate 40 and the adhesive layer 44, removed therefrom, is rotated by 180 degrees. Therefore, the state in which the intermediate resultant structure is rotated by 180 degrees is illustrated in this figure.

Referring to FIG. 4K, a polymer film 49 is adhered to the metal layer 45 and the polymer substrate 48. Here, the polymer film 49 may be formed of a polymer material having a glass transition temperature equal or similar to that of the polymer substrate 48. Subsequently, a pressure is applied to the polymer film 49 at a temperature of the glass transition temperature or more, thereby adhering the polymer film 49 to the metal layer 45 and the polymer substrate 48. For example, the polymer film 49 may be adhered using a press 50.

Referring to FIG. 4L, the polymer film 49 is etched, thereby forming a third opening OP3 exposing a second surface of the metal layer 45 therethrough. Accordingly, a polymer pattern 49A, i.e., a third mold is formed, which includes the third opening OP3. For example, after a metal layer, e.g., a Cr layer, which has etching resistance against oxygen plasma, is formed on the polymer film, the third opening OP3 may be formed through a lithography process using the oxygen plasma. Here, the Cr layer may a layer for protecting a passivation polymer layer, e.g., the other regions except an electrode to be exposed. In addition, the third opening OP3 may have a narrower width than the metal layer 45.

Referring to FIG. 4M, a second alloy layer 51 is formed in the third opening OP3. For example, the second alloy layer 51 including a first metal and a second metal may be formed, using electro-deposition, on the second surface of the metal layer 45. When the metal layer 45 is a Au electrode, an Ag—Au alloy layer may be formed.

Referring to FIG. 4N, the first metal included in the second alloy layer 51 is selectively removed, thereby forming a second nanoporous metal structure 51A. For example, Ag included in the Ag—Au alloy layer may be selectively dissolved using a nitric acid, thereby forming a nanoporous Au electrode. Accordingly, an adhesive structure is formed, in which the polymer substrate 48, the first nanoporous metal structure 47A in which the polymer is infiltrated into pores thereof, the metal layer 45, and the second nanoporous metal layer 51A are sequentially stacked.

By using the above-described manufacturing method, the first and second nanoporous metal structures 47A and 51A can be formed on the first and second surfaces of the metal layer, i.e., both surfaces of the metal electrode, respectively. Thus, the metal electrode and the polymer layer can be firmly adhered to each other. In addition, an electrode array including a plurality of such metal electrodes can be formed.

According to the present disclosure, a nanoporous structure and a polymer film are formed on a metal layer, and a polymer is then infiltrated into the nanoporous structure by applying heat or pressure to the polymer film Accordingly, the physical coherence between the polymer film and a metal layer can be increased, thereby improving the adhesion durability of the metal electrode. Particularly, a separate adhesive layer is not interposed between the polymer film and the metal layer, and thus there occurs no corrosion, separation, etc. Accordingly, the adhesive stability of the metal electrode in vivo or in vitro can be maintained for a long period of time. Also, the metal electrode can be applied in various fields including electrodes for body implantation or body attachment, and the like, which require long-term transplant stability.

Further, as the nanoporous structure is applied to the metal electrode, impedance can be decreased, thereby reducing electrical noise. Furthermore, it is possible to improve the performance of the metal electrode into which electric charges are injected.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A method for adhering a metal layer and a polymer layer, the method comprising:
forming a metal layer;
forming a nanoporous metal structure on the metal layer; and
compressing a polymer layer on the nanoporous metal structure such that a polymer is infiltrated into the nanoporous metal structure.

2. The method of claim 1, wherein the forming of the nanoporous metal structure includes:
forming, on the metal layer, an alloy layer including a first metal and a second metal; and
selectively dissolving the first metal using an etchant.

3. The method of claim 2, wherein the forming of the alloy layer is performed using electro-deposition.

4. The method of claim 2, wherein the first metal is gold and the second metal is silver, and
the silver is selectively dissolved using a silver etchant.

5. The method of claim 2, wherein the first metal is gold and the second metal is platinum, and
the gold is selectively dissolved using a gold etchant.

6. The method of claim 1, wherein the compressing of the polymer layer is performed at a temperature over a glass transition temperature.

7. The method of claim 1, wherein the compressing of the polymer layer is performed at a temperature of 50 to 300° C.

8. A method for manufacturing a metal electrode, the method comprising:
forming, on a sacrificial substrate, a first mold including a first opening having an undercut structure;
forming a metal electrode in the first opening;
forming a second mold including a second opening exposing the metal electrode therethrough;
forming a first nanoporous metal structure on a first surface of the metal electrode exposed through the second opening;
compressing a first polymer layer on the first nanoporous metal structure such that a polymer is infiltrated into the first nanoporous metal structure;
removing the sacrificial substrate such that a second surface of the metal electrode is exposed;
forming a third mold including a third opening exposing the second surface of the metal electrode therethrough; and
forming a second nanoporous metal structure on the second surface of the metal electrode exposed through the third opening.

9. The method of claim 8, wherein the forming of the first nanoporous metal structure includes:
forming, on the metal electrode, an alloy layer including a first metal and a second metal; and
selectively dissolving the first metal using an etchant.

10. The method of claim 8, wherein the forming of the second nanoporous metal structure includes:
forming, on the metal electrode, an alloy layer including a first metal and a second metal; and
selectively dissolving the first metal using an etchant.

11. The method of claim 8, wherein the compressing of the first polymer layer is performed at a temperature over a glass transition temperature.

12. The method of claim 8, wherein the compressing of the first polymer layer is performed at a temperature of 50 to 300° C.
